(19) United States
(12) Patent Application Publication
(10) Pub. No.: US 2006/0042017 A1
(43) Pub. Date: Mar. 2, 2006

(54) Combination of tool handle and spare tool inserted in the handle

(76) Inventor: Chorng-Jiang Lin, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/929,390

(22) Filed: Aug. 31, 2004

(51) Int. Cl. B26B 11/00

(52) U.S. Cl. 7/158; 7/167

(57) ABSTRACT

A tool includes a head and a hollow handle in which a spare tool is removably inserted. The handle includes a positioning device connected to an inner periphery of the handle and the spare tool has a notch with which a protrusion of the positioning device is engaged. The spare tool can be easily pulled out from the handle by hooking a tail portion on the spare tool by fingers.

### FIELD OF THE INVENTION

The present invention relates to a hollow tool handle with a spare tool inserted therein and a positioning device is connected in the handle so as to hold the spare tool.

### BACKGROUND OF THE INVENTION

A conventional tool such as a hammer includes a handle and a head which is fixed to an end of the handle. Generally, the handle is made of solid wood rod and cannot be connected with spare tool such as a knife. Although some tool manufacturers develop hollow handles in which a spare tool is received. The spare tool usually is threadedly connected to the handle and this requires a lot of machining processes. Besides, the threads have to be defined in a thick wall of the handle and the spare tool has to be rotated several revolutions to disengaged from the handle. If the handle is small, it will be difficult to form threads therein.

The present invention intends to provide a tool handle that includes a positioning device in the handle and the spare tool can be engaged with the positioning device. The spare tool is easily to be positioned in and pulled from the handle.

### SUMMARY OF THE INVENTION

The present invention relates to a tool that comprises a head and a handle which includes a hollow interior with an opening through which a spare tool is inserted. A positioning device is connected to an inner periphery of the handle and the spare tool has a notch defined in an outer periphery thereof such that the positioning device is disengageably engaged with the notch.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the spare tool and the handle of the present invention;

FIG. 2 is a cross sectional view to show the spare tool is received in the handle;

FIG. 3 shows a bottom view of the handle;

FIG. 4 shows that the user's fingers pulls the tail portion of the spare tool;

FIG. 5 shows the user holds the spare tool with his or her little finger put in the notch;

FIG. 6 shows another embodiment of the positioning device of the present invention;

FIG. 7 shows yet another embodiment of the positioning device of the present invention;

FIG. 8 shows that the handle is connected to another head, and

FIG. 9 shows that the handle is connected to a blade.

### DETAILED DESCRIPTION OF THE PREFERRED EMBODIMENT

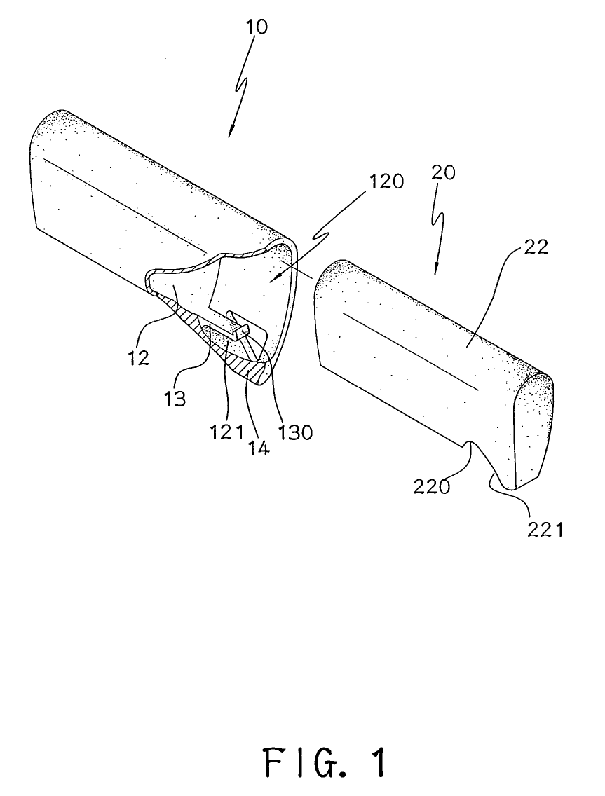

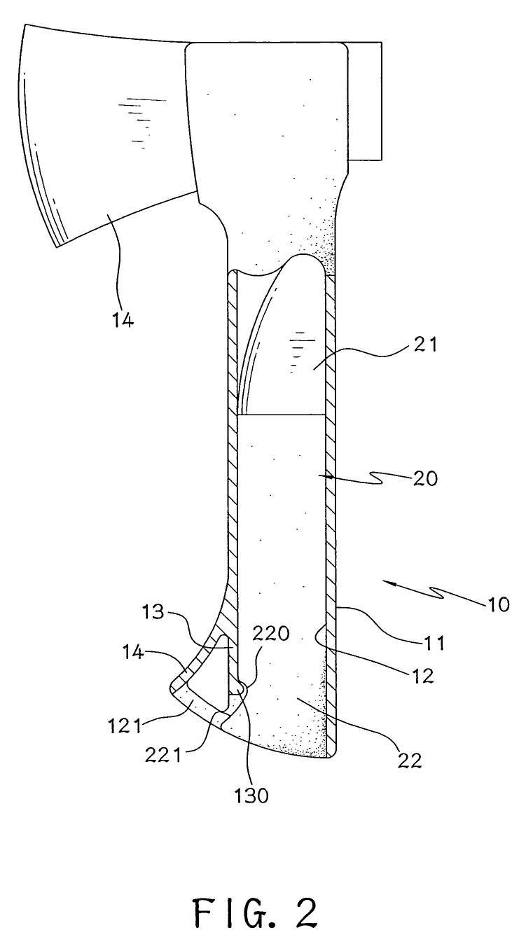

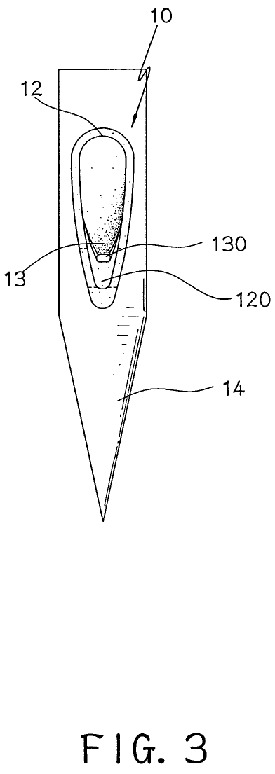

Referring to FIGS. 1 to 3, the tool 10 of the present invention comprises an axe head 14 and a handle 11 which includes a hollow interior 120 with an opening defined in an end of the handle 11. A positioning device 13 such as a flexible plate is connected to an inner periphery 12 of the handle 10 and a protrusion 130 extends laterally from an end of the positioning device 13. An extension portion 14 extends laterally from an outer periphery of the handle 11 and an open space 121 is defined between the positioning device 13 and the extension portion 14.

A spare tool 20 includes a function end 21 and a grip 22, the spare tool 20 is inserted in the handle 11. The grip 22 has a notch 220 defined in an outer periphery thereof and a tail portion 221 extends laterally from the spare tool 20 and one side of the tail portion 221 extends from an inner periphery of the notch 220. The protrusion 130 is engaged with the notch 220 of the spare tool 20 and the tail portion 221 is accessible via the open space 121.

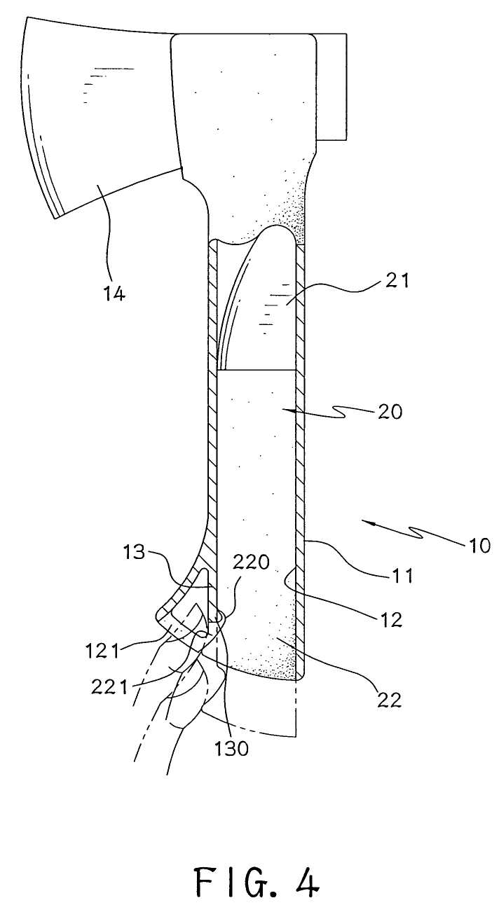

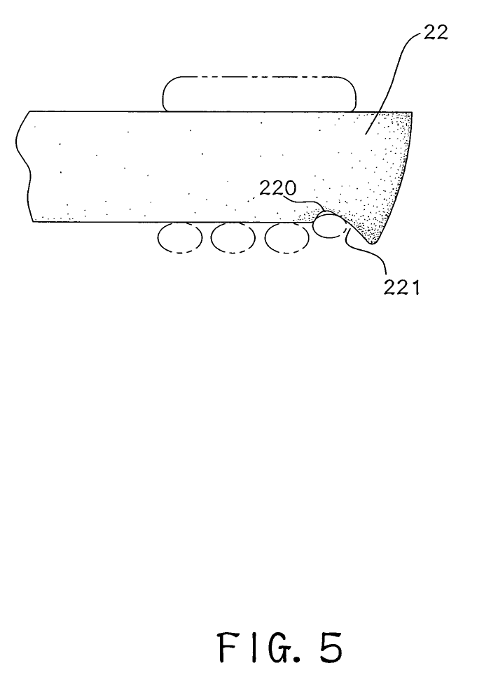

Referring to FIGS. 4 and 5, the user conveniently inserts fingers in the open space 121 and hooks and pulls the tail portion 221 so that the spare tool 20 can be pulled out from the handle 11. The user holds the spare tool 20 with his or her little finger put in the notch 220 and this allows the user to hold the spare tool 20 firmly.

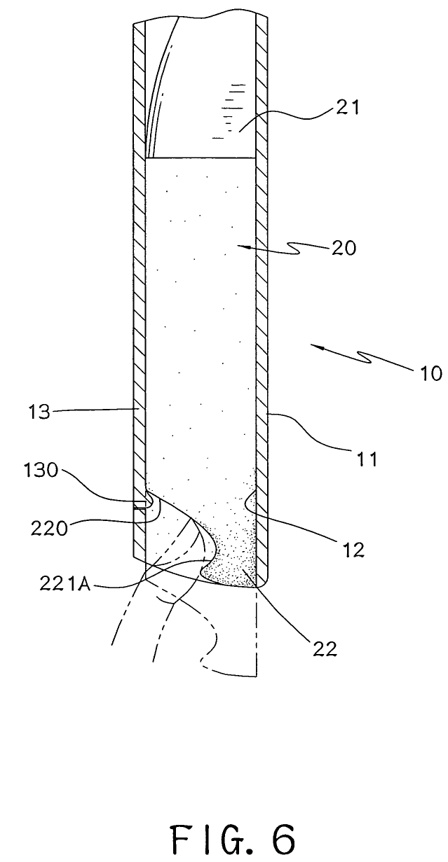

FIG. 6 shows that the positioning device 13 is formed on the wall of the handle 11 and the protrusion 130 extends from the inner periphery 12 of the handle 11. A slit is cut to separate the protrusion 130 and the wall of the handle 11 so that the protrusion 130 has proper flexibility. The spare tool 20 includes a notch 220 and a hook portion 221 A is formed in a distal end of the spare tool 20. The protrusion 130 can be pushed outward by the spare tool 20 when the spare tool 20 is inserting into the handle 11 till the protrusion 130 engaged with the notch 220 to position the spare tool 20. The user may hook the hook portion 221 A to pull the spare tool 20 out.

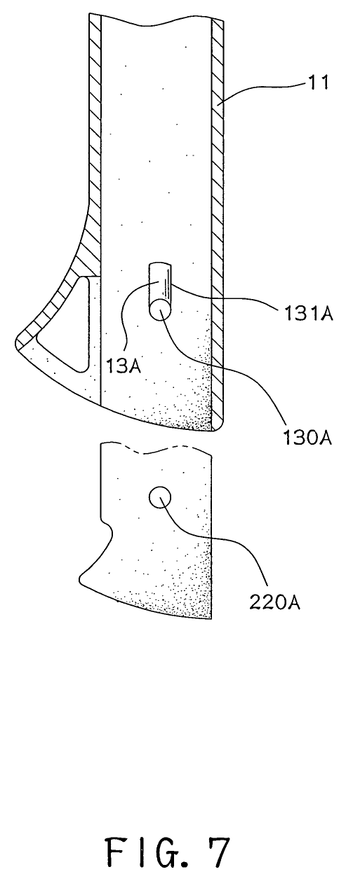

FIG. 7 shows that the positioning device can be a strip 13A split from the wall of the handle 11 by two slits 131A on two sides of the strip 13A. A protrusion 130A is formed at a distal end of the strip 13a and the spare tool 20 further includes a recess 220A with which the protrusion 130A is engaged.

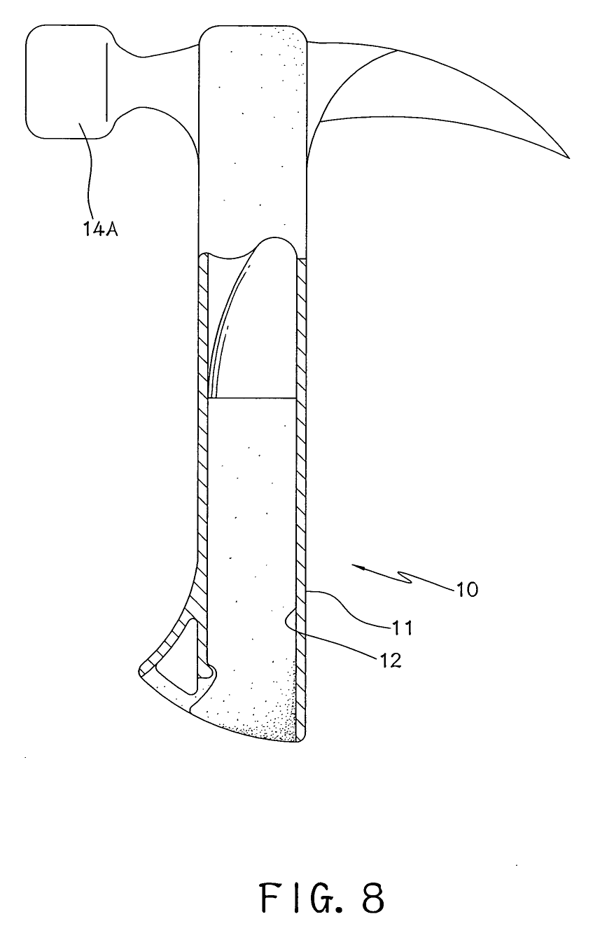

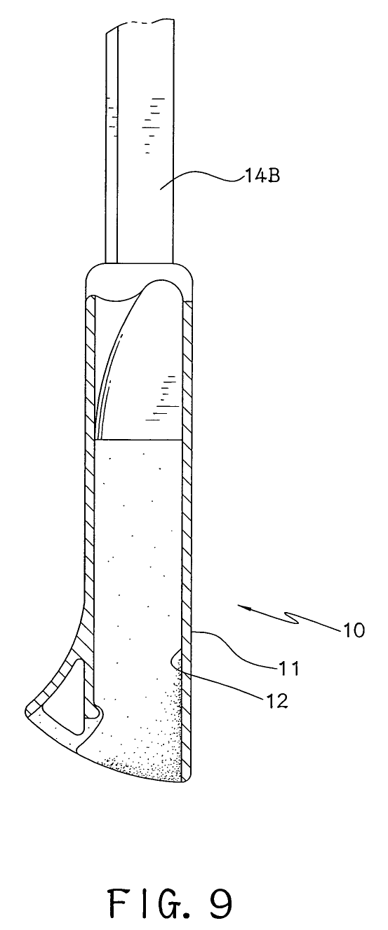

FIG. 8 shows that the handle 11 is connected to another head 14A. As shown in FIG. 9, the handle 11 is connected to a blade 14B.

While we have shown and described the embodiment in accordance with the present invention, it should be clear to those skilled in the art that further embodiments may be made without departing from the scope of the present invention.

What is claimed is:

1. A tool comprising:
A head (14) and a handle (11) which includes a hollow interior (120) with an opening, a positioning device (13) connected to an inner periphery (12) of the handle (10), and
a spare tool (20) having a notch (220) defined in an outer periphery thereof and the positioning device disengageably engaged with the notch (220).

2. The tool as claimed in claim 1, wherein the positioning device (13) is a flexible plate and has a protrusion (130) which is engaged with the notch (220) of the spare tool (20).

3. The tool as claimed in claim 1, wherein a tail portion (221) extends laterally from the spare tool (20) and one side of the tail portion (221) extends from an inner periphery of the notch (220).

4. The tool as claimed in claim 1, wherein an extension portion (14) extends laterally from an outer periphery of the handle (11) and an open space (121) is defined between the positioning device (13) and the extension portion (14), the tail portion (221) being accessible via the open space (121).
